(19) United States
(12) Patent Application Publication
(10) Pub. No.: US 2012/0009299 A1
(43) Pub. Date: Jan. 12, 2012

(54) MICROWAVABLE FROZEN COOKIE DOUGH

(75) Inventor: Feng Xie, Overland Park, KS (US)

(73) Assignee: CARAVAN INGREDIENTS INC., Lenexa, KS (US)

(21) Appl. No.: 12/834,713

(22) Filed: Jul. 12, 2010

(51) Int. Cl. A21D 10/02; A21D 2/08; A21D 8/00

(52) U.S. Cl. 426/20; 426/243; 426/61; 426/64; 426/549

(57) ABSTRACT

A microwavable cookie dough composition is provided, along with methods of microwave-baking cookies. The cookie dough can be microwave-baked from the raw, frozen state without thawing or pre-baking. The cookie dough also does not require the use of a susceptor to achieve even heating. The resulting cookie has acceptable spread, crumb structure, and texture comparable to a conventional oven-baked cookie.

### BACKGROUND OF THE INVENTION

1. Field of the Invention

The present invention relates to a cookie dough that can be baked from the raw, frozen state using a microwave oven to yield a cookie having the taste and texture of a traditional oven-baked cookie.

2. Description of Related Art

A variety of prepackaged, ready-to-bake cookie dough formulations have been developed over the years to the save time and effort of baking cookies from scratch. Such products come in refrigerated logs that can be sliced into cookie and baked, or in tubs from which the cookie dough can be scooped and dropped onto a baking sheet. Despite this, there is still an ever-increasing demand for added convenience in baking cookies, and more recently, refrigerated cookie dough products are being provided on trays as individually-shaped dough pieces that simply need to be set on a cookie sheet with no slicing or scooping. However, existing refrigerated and frozen cookie doughs must still be baked in a conventional oven, which involves preheating the oven and then baking the cookies for at least ten minutes or more. The entire process can take as long as fifteen to twenty minutes. Therefore, the industry is constantly searching for more rapid methods of baking cookies.

Food baked in a traditional oven is heated by conduction from the outside to the inside. In contrast, microwave ovens work by penetrating the food and exciting water and fat molecules in the food. Unlike conventional baking, heat does not migrate towards the center of the food via conduction, rather, microwave ovens generate heat inside and throughout the body of the food. As a result, the food is cooked much more rapidly. However, this also means that moisture is driven from the inside of the food at a much higher rate than conventional baking. Therefore, a common outcome in microwave baking using traditional cookie dough (including ready-to-bake refrigerated or frozen dough) is overcooked or burnt spots in the center of the cookie, while the edges of the food remain undercooked. Also, microwaved dough products usually become hard shortly after microwave baking, because of the rapid and extensive heating which drives the moisture from the dough. Traditional cookie dough also spreads too thin when cooked in a microwave oven, resulting in a flat cookie with inferior texture, crumb structure, and overall quality. Therefore, microwaves have traditionally been deemed unsuitable for cooking certain types of foods such as cookies.

More recently, however, attempts have been made to formulate cookie dough suitable for microwave cooking. Such methods still rely in part on conduction heating methods and require the use of a susceptor to control the dough spread and promote even heating during microwave baking. Susceptors are commonly built into paper packaging to create a “browning” or “crisping” effect in certain microwavable foods where this is desirable, such a pizza and frozen pies. Susceptors absorb microwave radiation, which raises the temperature of the susceptor, and in turn results in conduction heating of the food in contact with the susceptor, similar to baking in a conventional oven. Heating can also occur via infared radiation where the susceptor is not in contact with the food, but radiates heat back onto it. Some microwavable food products use both methods (e.g., Hot Pockets®). Although the ability to bake a cookie in the microwave increases the convenience of baking cookies, the requirement of a susceptor, as in existing microwavable cookie dough formulations, is a countervailing inconvenience. That is, part of the convenience of a ready-to-bake refrigerated or frozen cookie dough is the ability to bake only a few cookies (from the log or tub) at a time, so they can be enjoyed, each time, fresh out of the oven. Therefore, consumers wishing to bake only a few of the current microwavable cookies must retain the susceptor for later use to bake the rest of the cookies. It is not clear if such susceptors can be cleaned, or are even designed to be used multiple times. Moreover, the susceptor necessarily adds to the cost of the package, which may outweigh the convenience factor for many consumers. Other recent attempts at microwave-baked cookies require a pre-bake step in a conventional oven before packaging, and don't involve microwave-baking of a raw dough. Again, this additional step necessarily increases the cost of such products.

Accordingly, there is still a need in the art for a cookie dough formulation that can be “microwave-baked,” but does not require any special elements, such as a susceptor, to achieve a cookie having an acceptable spread, crumb structure, texture, and overall quality. It would be further advantageous if the microwavable cookie dough formulation could be microwave-baked directly from a raw, frozen state.

### SUMMARY OF THE INVENTION

The present invention is broadly concerned with methods of microwave-baking a cookie. In one aspect, the method comprises placing a frozen piece of cookie dough in a microwave oven, and microwaving the cookie dough to yield a microwave-baked cookie, without the use of susceptor for microwave-baking.

The present invention also provides inventive microwavable cookie dough compositions. The compositions comprise from about 0.01% to about 20% by weight corn syrup solids, from about 0.1% to about 0.8% by weight glycerin, and from about 0.1% to about 5% by weight of a gum system, along with an enzyme, dough conditioner, a chemical leavening agent, a carrier, flour, a sweetening agent, egg, and fat, wherein the % by weight are based upon the total weight of the composition taken as 100% by weight.

A generally disc-shaped cookie dough piece having an outer perimeter and an upper surface is also provided. The dough piece has a first average thickness around the outer perimeter, and an upper surface including a depression formed therein and having a second average thickness. The second average thickness is from about 0% to about 30% of the first average thickness.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1A is a photograph of a microwave-baked sugar cookie and the unbaked (raw) dough from Example 1;

FIG. 1B depicts a top view of a generally disc-shaped cookie dough piece having a depression in accordance with the invention;

FIG. 1C depicts an isometric view of a generally disc-shaped cookie dough piece having a depression in accordance with the invention;

FIG. 2 is a photograph of two microwave-baked chocolate chip cookies from Example 2;

FIG. 3 is a photograph of microwave-baked, conventional refrigerated chocolate chip cookies (top row, all top views of cookies), and the inventive microwave-baked cookie (bottom row, top view and bottom view of cookie) from Example 2;

FIG. 4 is a photograph comparison showing the difference in crumb structure between microwave-baked, conventional refrigerated chocolate chip cookie dough (right), and the inventive microwave-baked dough (left) from Example 2;

FIG. 5 is a photograph of the top and bottom of the microwave-baked oatmeal raisin cookie from Example 3; and

FIG. 6 is a set of photographs of the top (A) and bottom (B) of the microwave-baked chocolate chip cookie from Example 4, the top (C) and bottom (D) of the microwave-baked oatmeal raisin cookie from Example 4, and the top (E) and bottom (F) of the microwave-baked sugar cookie from Example 4.

### DETAILED DESCRIPTION OF THE INVENTION

The present invention is concerned with microwavable cookie dough formulations that can be microwave-baked from a raw, frozen state, without the aid of a susceptor or other additional heating apparatus. The microwavable cookie dough composition comprises a mixture of corn syrup solids, glycerin, an enzyme, a gum system, a dough conditioner, a chemical leavening agent, and a carrier, in addition to flour, sweetening agents, egg, and fat found in traditional cookie doughs. The dough also comprises additional ingredients selected from the group consisting of cereals (e.g., oats), food pieces, flavoring agents, spices, salt, milk solids, and mixtures thereof. Advantageously, the dough composition can be microwave-baked from the frozen state to yield a cookie having a taste and texture similar to conventional oven-baked cookies.

In more detail, the inventive dough composition comprises from about 0.01% to about 20% by weight corn syrup solids, preferably from about 2% to about 20% by weight corn syrup solids, more preferably from about 2% to about 10% by weight corn syrup solids, and even more preferably from about 4% to about 8% by weight corn syrup solids, based upon the total weight of the composition taken as 100% by weight. Preferred corn syrup solids have a dextrose equivalence (DE) value of from about 20 to about 60, and more preferably from about 30 to about 50. Suitable corn syrup solids are readily, commercially-available. The composition also comprises from about 0.1% to about 0.8% by weight glycerin, preferably from about 0.2% to about 0.6% by weight glycerin, and more preferably from about 0.3% to about 0.5% by weight glycerin, based upon the total weight of the composition taken as 100% by weight.

The dough composition comprises from about 0.001% to about 0.6% by weight enzyme, preferably from about 0.05% to about 0.5% by weight enzyme, and more preferably from about 0.1% to about 0.3% by weight enzyme, based upon the total weight of the composition taken as 100% by weight. Preferred enzymes include carbohydrases such as those selected from the group consisting of amylases (α-, β-, or iso-), glucosidases, cellulases, xylanases, transglutaminases, and mixtures thereof. A particularly preferred enzyme for use in the dough composition is α-amylase.

The dough composition preferably comprises from about 0.01% to about 0.5% by weight dough conditioner, preferably from about 0.02% to about 0.45% by weight dough conditioner, and more preferably from about 0.03% to about 0.4% by weight dough conditioner, based upon the total weight of the composition taken as 100% by weight. Suitable dough conditioners include sodium stearoyl lactylate, calcium stearoyl lactylate, mono- and diglycerides, and combinations thereof, with sodium stearoyl lactylate being preferred.

The gum system preferably comprises a gum selected from the group consisting of comprises xanthan gum, guar gum, cellulose derivatives, locust bean gum, agar, pectin, and combinations thereof, with a combination of xanthan gum, guar gum, and cellulose derivatives being preferred. The total gum system content in the composition is preferably from about 0.1% to about 5% by weight, preferably from about 0.15% to about 4% by weight, and more preferably from about 0.2% to about 3% by weight, based upon the total weight of the composition taken as 100% by weight. More preferably, the dough composition comprises from about 0.1% to about 5% by weight xanthan gum, more preferably from about 0.15% to about 4% by weight xanthan gum, and even more preferably from about 0.2% to about 3% by weight xanthan gum, based upon the total weight of the composition taken as 100% by weight. Guar gum is preferably present in the composition at a level of from about 0.1% to about 5% by weight, more preferably from about 0.15% to about 4% by weight, and even more preferably from about 0.2% to about 3% by weight, based upon the total weight of the composition taken as 100% by weight. The composition preferably comprises from about 0.1% to about 5% by weight cellulose derivatives, more preferably from about 0.15% to about 4% by weight cellulose derivatives, and even more preferably from about 0.2% to about 3% by weight cellulose derivatives, based upon the total weight of the composition taken as 100% by weight. Preferred cellulose derivatives include carboxymethyl cellulose, methylcellulose, hydroxypropylcellulose, hydroxypropyl-methylcellulose, ethyl-methylcellulose, and derivatives thereof. A particularly preferred cellulose derivative for use in the gum system is sodium carboxymethylcellulose. Preferably, the xanthan, guar, and cellulose derivatives are included in the gum system in a 1:1:1 ratio by weight.

The dough composition also preferably comprises from about 0.05% to about 0.5% by weight chemical leavening agent, more preferably from about 0.1% to about 0.45% by weight chemical leavening agent, and even more preferably from about 0.15% to about 0.4% by weight chemical leavening agent, based upon the total weight of the composition taken as 100% by weight. As used herein, the term “chemical leavening agent” means a non-yeast leavener, such as baking powder or baking soda, with baking soda being particularly preferred.

The carrier is preferably present in the dough composition at a level of from about 1% to about 40% by weight, more preferably from about 2% to about 35% by weight, and even more preferably from about 3% to about 30% by weight, based upon the total weight of the composition taken as 100% by weight. Preferred carriers are non-gluten flours and starches selected from the group consisting of rice flour, tapioca starch, corn starch, sweet potato starch, tapioca flour, corn flour, brown rice flour, sorghum flour, potato flour, amaranth flour, millet flour, quinoa flour, teff flour, and mixtures thereof.

The dough composition also preferably comprises from about 1% to about 60% by weight flour, more preferably from about 2% to about 55% by weight flour, and even more preferably from about 5% to about 50% by weight flour, based upon the total weight of the composition taken as 100% by weight. Suitable flours for use in the dough are preferably wheat flours selected from the group consisting of pastry flour, cake flour, all-purpose flour, and mixtures thereof, with pastry flour being particularly preferred.

The dough composition also preferably comprises a sweetening agent (not including corn syrup solids). Suitable sweetening agents for use in the dough composition include both natural and artificial sweeteners. The total sweetening agent (natural and artificial) in the composition is preferably from about 5% to about 50% by weight, and more preferably from about 6% to about 40% by weight, based upon the total weight of the composition taken as 100% by weight. Suitable natural sweeteners are selected from the group consisting of granulated sugars (white sugar, brown sugar), molasses (liquid), honey, maple syrup, corn syrup, brown rice syrup, golden syrup, stevia, and mixtures thereof, with granulated sugar and molasses being particularly preferred. The total amount of natural sweeteners in the composition is preferably from about 5% to about 50% by weight, and more preferably from about 6% to about 40% by weight, based upon the total weight of the composition taken as 100% by weight. More specifically, the dough composition preferably comprises from about 1% to about 40% by weight granulated sugar, more preferably from about 2% to about 35% by weight granulated sugar, and even more preferably from about 3% to about 30% by weight granulated sugar, based upon the total weight of the composition taken as 100% by weight. When present, the composition also preferably comprises from about 0.01% to about 20% by weight molasses, more preferably from about 1% to about 10% by weight molasses, and even more preferably from about 1% to about 5% by weight molasses, based upon the total weight of the composition taken as 100% by weight. Advantageously, molasses also contributes to color formation (i.e., browning) in the cookie that simulates the look of a conventionally-baked cookie. Suitable artificial sweeteners for use in the dough composition are selected from the group consisting of sucralose, aspartame, neotame, acesulfame potassium, saccharin, and mixtures thereof, with sucralose being particularly preferred. The dough composition preferably comprises from about 0.001% to about 0.5% by weight artificial sweetener, more preferably from about 0.005% to about 0.25% by weight artificial sweetener, and even more preferably from about 0.01% to about 0.2% by weight artificial sweetener, based upon the total weight of the composition taken as 100% by weight.

The dough composition also preferably comprises from about 1% to about 30% by weight fat, more preferably from about 2% to about 25% by weight fat, and even more preferably from about 3% to about 20% by weight fat, based upon the total weight of the dough taken as 100% by weight. Suitable fats are preferably plastic (solid) fats selected from the group consisting of shortenings, margarine, and butter. A particularly preferred fat for use in the dough composition is a trans fat free shortening formulated using high diglyceride Trancendim™ emulsifiers (Caravan Ingredients), available from Ventura Foods (Brea, Calif.).

The dough composition also preferably comprises from about 1% to about 40% by weight eggs, more preferably from about 3% to about 30% by weight eggs, and even more preferably from about 5% to about 25% by weight eggs, based upon the total weight of the composition taken as 100% by weight. Whole, fresh eggs are preferably used, although egg whites or liquid egg products may be substituted for part or all of the eggs in the dough composition.

Depending upon the cookie type, cereals and/or food pieces can also be included in the dough composition. Examples of suitable cereals include rolled oats, barley, crisp rice, and mixtures thereof. When present, the dough composition preferably comprises from about 1% to about 45% by weight cereal, more preferably from about 3% to about 40% by weight cereal, and even more preferably from about 5% to about 35% by weight cereal, based upon the total weight of the composition taken as 100% by weight. Exemplary food pieces that can also be included in the dough composition include those selected from the group consisting of chocolate chips, chocolate chunks, fruit pieces (raisins, cranberries, etc.), nuts, peanut butter chips, toffee, and combinations thereof. When present, the dough composition preferably comprises from about 1% to about 40% by weight food pieces, more preferably from about 1% to about 35% by weight food pieces, and even more preferably from about 2% to about 30% by weight food pieces, based upon the total weight of the composition taken as 100% by weight.

It will be appreciated that the cookie dough composition will also include a variety of flavoring agents, spices, salt, and mixtures thereof, depending upon the type of cookie. Suitable flavoring agents include vanillin, vanilla, smoke, mint, cocoa, almond, butter, chocolate, and mixtures thereof. The flavoring agent is preferably included at a level of from about 0.01% to about 0.6% by weight, more preferably at a level of from about 0.03% to about 0.5% by weight, and even more preferably at a level of from about 0.05% to about 0.4% by weight, based upon the total weight of the composition taken as 100% by weight. Suitable spices include cinnamon, ginger, black pepper, fennel, onion, anise, cumin, chive, garlic, paprika, and mixture thereof. When present, the composition preferably comprises from about 0.001% to about 5% by weight spices, more preferably from about 0.01% to about 3% by weight spices, and even more preferably from about 0.05% to about 1% by weight spices, based upon the total weight of the composition taken as 100% by weight. Salt is preferably included in the composition at a level of from about 0.001% to about 1% by weight, more preferably at a level of from about 0.001% to about 0.75% by weight, and even more preferably at a level of from about 0.01% to about 0.5% by weight, based upon the total weight of the composition taken as 100% by weight.

Additional ingredients that can be included in the dough composition include milk solids, whey solids, egg powder, yogurt powder, and combinations thereof. Particularly preferred milk solids include nonfat dry milk (NFDM). When present, the composition preferably comprises from about 0.01% to about 15% by weight milk solids, more preferably from about 0.5% to about 10% by weight milk solids, and even more preferably from about 0.75% to about 5% by weight milk solids, based upon the total weight of the composition taken as 100% by weight.

The wet ingredients are preferably present in the composition at a level of from about 5% to about 30% by weight, more preferably from about 7% to about 25% by weight, and even more preferably from about 10% to about 20% by weight. Preferably, the total ratio of wet to dry ingredients in the composition is from about 5:95 to about 30:70, preferably from about 7:93 to about 25:75, and even more preferably from about 10:90 to about 20:80.

The composition is formed by creaming the natural sweeteners with the fat until smooth. More specifically, the sugar and molasses (if any) are combined with the fat at low speed for about 30 to about 120 seconds, and more preferably about 1 minute, and then mixed at high speed for about 2 to about 6 minutes, and more preferably about 4 minutes until a smooth creamy mixture is formed. The egg is added, followed by mixing for about 1 to about 4 minutes at high speed, and preferably about 2 minutes. The remaining ingredients (e.g., corn syrup solids, glycerin, enzyme(s), gum system, dough conditioner, leavening agent, and carrier, along with flour, artificial sweeteners, cereals (e.g., oats), food pieces, flavoring agents, spices, salt, and milk solids, if any) are then added followed by mixing at low speed for about 1 to about 6 minutes, and preferably about 2 minutes until the ingredients are substantially uniformly combined and a dough has formed. Alternatively, the egg can be incorporated into the dough as the last step of the method, after the other ingredients have already been combined with the creamed mixture.

In one embodiment, the corn syrup solids, glycerin, enzyme(s), gum system, dough conditioner, and chemical leavening agent, can be provided in a premix composition along with a portion of the total carrier to be included in the dough. The artificial sweetener, flavoring agents, and salt can also be included in the premix. This premix is then combined with the flour, and remaining portion of the carrier, along with any food pieces or other dry ingredients before being mixed with the creamed mixture and egg. In either case, the total moisture in the resulting dough is preferably from about 5% to about 30% by weight, more preferably at a level of from about 7% to about 25% by weight, and even more preferably at a level of from about 10% to about 20% by weight, based upon the total weight of the dough composition taken as 100% by weight. However, it is preferred that additional water not be added to the dough. That is, moisture in the cookie dough is preferably attributable solely to the inherent moisture of the ingredients.

Prior to freezing, the dough is portioned into pieces that can be baked into individual cookies directly from the frozen stage. In more detail, the dough is preferably portioned into 5 g to about 120 g pieces, more preferably from about 20 g to about 100 g pieces, and even more preferably from about 40 g to about 80 g pieces. It will be appreciated that the pieces can be shaped in a variety of ways before being frozen, or the dough could simply be scooped and “dropped” onto a substrate (plate, sheet, etc.) before being frozen. It is particularly preferred that the pieces are shaped into a ball and then flattened into a substantially circular disc having a substantially uniform thickness. The dough pieces can also be shaped into a disc (i.e., circle) by rolling into a log and slicing pieces of dough for individual cookies. Preferably, the disc has an average thickness of from about 0.05 to about 2 inches, more preferably from about 0.1 to about 1 inches, and even more preferably from about 0.15 to about 0.6 inches. The average thickness of the disc is determined by measuring the thickness of the disc at multiple (e.g., 4) points, and these measurements are then averaged to determine the average thickness of the disc. The disc also preferably has a maximum surface-to-surface dimension (e.g., diameter if a circle) of from about 0.5 to about 6 inches, more preferably from about 1 to about 5 inches, and even more preferably from about 1.5 to about 4 inches. To ensure even baking, the thickness of the dough is preferably from about 1% to about 40% of the overall maximum surface-to-surface dimension (e.g., diameter) of the dough piece, more preferably from about 3% to about 30%, even more preferably from about 5% to about 20%, and most preferably about 10% of the overall maximum surface-to-surface dimension (e.g., diameter) of the dough piece.

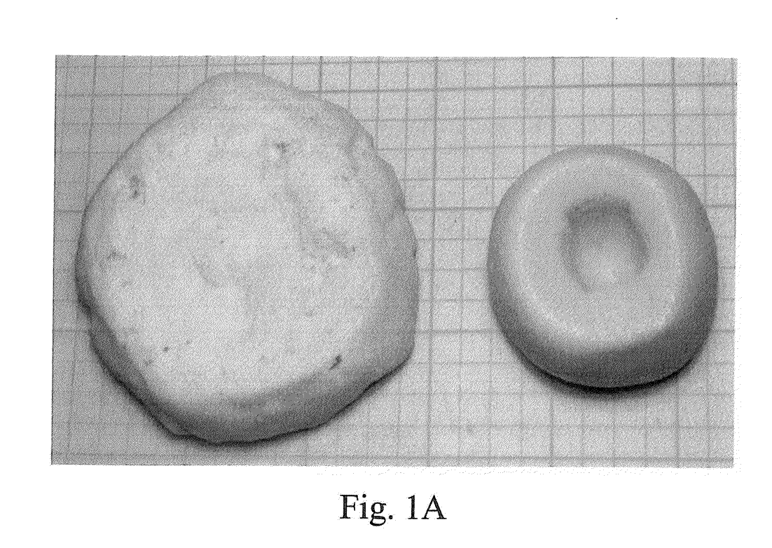

In another embodiment, a depression or hole can be formed in the center of the generally disc-shaped pieces as shown in FIGS. 1A-1C, such that the center thickness of the dough pieces is substantially less than the thickness of the outer edges of the dough pieces. With references to FIGS. 1B-1C, a generally disc-shaped dough piece 10 is provided, and having an outer perimeter 12 and an upper surface 14. The dough piece 10 has a first average thickness T around the perimeter 12. The upper surface 14 includes a depression 16. The dough below the depression 16 has a second average thickness T′ of preferably from about 0% to about 30% of the first average thickness T, and more preferably from about 5% to about 20% of the first average thickness T. More specifically, the second average thickness T′ is preferably from about 0 to about 0.6 inches, and more preferably from about 0.05 to about 0.4 inches.

The depression 16 preferably has an average “hole” height H, as measured from the bottom of the depression to the upper surface 14, of from about 1.4 inches to about 2 inches, and more preferably from about 1.6 inches to about 1.9 inches. This height H is preferably from about 70% to about 100% of the first average thickness T of the dough piece, and more preferably from about 80% to about 95% of the first average thickness T. Thus, the height H of the depression and the second average thickness T′ of the dough below the depression will add up to equal the first average thickness T of the dough piece.

The dough piece 10 preferably has an average diameter D of from about 2 inches to about 6 inches, more preferably from about 2.1 inches to about 5.5 inches, and even more preferably from about 2.5 inches to about 5 inches. The depression 16 preferably has an average diameter D′ of from about 0.2 inches to about 3 inches, more preferably from about 0.4 inches to about 2.4 inches, and even more preferably from about 0.5 to about 2 inches. Preferably, the average diameter D′ of the depression 16 is from about 10% to about 50% of the average diameter D of the dough piece 10, and more preferably from about 20% to about 40% of the average diameter D.

The dough can also be provided in the form of a sheet having score lines and grooves for separation of the dough into individual pieces before microwave-baking.

Regardless of the manner of shaping, the shaped dough pieces are then frozen. Preferably, the dough is frozen to a temperature of from about −15° C. to about −35° C., and more preferably from about −20° C. to about −30° C. Once frozen, the dough pieces can be stored at about −20° C.

For microwave baking, the dough is removed from the freezer and placed in a microwave. Advantageously, there is no need to thaw the dough before microwave baking. There is also no need to use a special susceptor or other additional heating apparatus to microwave-bake the dough. Preferably, the frozen dough piece is placed on a microwave safe surface and microwave-baked from the raw frozen state. In a preferred embodiment, the dough pieces are placed offset from the center of the microwave. The microwave output is preferably from about 500 W to about 2000 W, and more preferably from about 800 W to about 1500 W. The dough is also preferably microwave-baked at a power level of from about 10% to about 60%, and more preferably at a power level of from about 20% to about 50%. The baking time per cookie will preferably range from about 30 to about 240 seconds, more preferably from about 40 to about 200 seconds, and even more preferably from about 50 to about 180 seconds. It will be appreciated that the baking time will vary due to microwave oven variations (energy output) as well as the power level, and is inversely proportional to the power level and microwave energy output used. That is, the time should be increased for lower energy output and/or energy level, and decreased for higher energy output and/or power level. Likewise, the microwave baking time is increased when more than one dough piece is microwaved at a time. If desired, the top and bottom of the dough discs can be sprayed with a browning agent before microwave baking. Suitable browning agents include Maillose® (available from Red Arrow; Manitowoc, Wis.).

Advantageously, the resulting microwave-baked cookie has the appearance and texture of a traditional oven-baked cookie. The cookie preferably has minimal spread. That is, the maximum surface-to-surface dimension (e.g., diameter if a circle) of the microwave-baked cookie is preferably less than about 40% greater than the maximum surface-to-surface dimension (e.g., diameter if a circle) of the beginning frozen dough piece, and more preferably from about 5% to about 30% greater than the maximum surface-to-surface dimension of the frozen dough piece. For example, if the frozen dough disc has a beginning diameter of about 3 inches, the diameter of the resulting microwave-baked cookie is preferably only about 30% larger than the beginning diameter (i.e., the resulting microwave-baked cookie has a diameter of about 3.9 inches). Put another way, the ratio between the maximum surface-to-surface dimension of the dough:microwave-baked cookie is preferably from about 1:1.01 to about 1:1.5, more preferably from about 1:1.05 to about 1:1.45, and even more preferably from about 1:1.1 to about 1:1.4. Thus, the microwave-baked cookie preferably has a maximum surface-to-surface dimension of from about 0.51 to about 9 inches, and even more preferably from about 0.53 to about 8.7 inches. The cookie also preferably maintains its texture and remains moist and chewy for a period of time after microwave-baking and does not become hard as in prior microwave-baked cookies. When subjected to a firmness test, as described in Example 4, the microwave-baked cookie preferably has a firmness of from about 1500 to about 4500, more preferably from about 1600 to about 4400, and even more preferably from about 1700 to about 4300. In addition, when subjected to the cohesivness test, as described in Example 4, the microwave-baked cookie preferably has a cohesiveness of from about 0.2 to about 0.5, more preferably from about 0.25 to about 0.45, and even more preferably from about 0.3 to about 0.4. Furthermore, when subjected to the chewiness test, as described in Example 4, the microwave-baked cookie preferably has a chewiness of from about 100 to about 1100, more preferably from about 200 to about 1000, and even more preferably from about 300 to about 900. Finally, when subjected to a springiness test, as described in Example 4, the microwave-baked cookie preferably has a springiness of from about 0.3 to about 0.8, more preferably from about 0.35 to about 0.75, and even more preferably from about 0.4 to about 0.7. Preferably, these texture characteristics are maintained for at least about 0.5 hours after microwave-baking, and more preferably from about 0.75 hours to about 1 hour after microwave-baking. The moisture content of the microwave-baked cookie is preferably from about 11% to about 20% by weight, more preferably from about 12% to about 19% by weight, and even more preferably from about 13% to about 18% by weight, based upon the total weight of the cookie taken as 100% by weight.

Although the primary advantage of the inventive cookie dough is that it can be microwave-baked, the dough is also suitable for traditional oven baking. The frozen dough can be thawed and then baked in a traditional oven at about 350° F. for about 12 to about 16 minutes. Thus, the invention provides the advantage that the dough is suitable for both oven and microwave baking, depending upon the ultimate desired method of baking to be used.

### EXAMPLES

The following examples set forth methods in accordance with the invention. It is to be understood, however, that these examples are provided by way of illustration and nothing therein should be taken as a limitation upon the overall scope of the invention.

### Example 1

### Sugar Cookie

In this Example, a sugar cookie dough was prepared from the ingredients in Table 1 below, frozen, and then baked in a microwave oven directly from the raw, frozen stage (i.e., without thawing or pre-baking). The dough was prepared using a commercial mixer by first creaming the granulated sugar and trans-fat free shortening (Trancendim™; available from Ventura Foods, Brea, Calif.) until smooth. The remaining ingredients except for the egg were then added and mixed until homogenous. The egg was then added and mixed until a dough formed.

TABLE 1
Sugar Cookie Dough

| Ingredients | % by weight^{A} |
|---|---|
| Granulated Sugar | 22.34 |
| Trans-fat free shortening | 10.16 |
| Fresh Egg | 14.22 |
| Pastry Flour | 25.25 |
| Tapioca Starch | 21.74 |
| Corn Syrup Solids | 2.86 |
| Glycerin | 0.65 |
| Baking Powder | 0.49 |
| Sodium Stearoyl Lactylate | 0.41 |
| Sodium Carboxymethyl Cellulose | 0.41 |
| Guar Gum | 0.41 |
| Xanthan Gum | 0.41 |
| α-Amylase | 0.33 |
| Vanillin | 0.18 |
| Salt | 0.11 |
| Sucralose | 0.03 |

^{A}based upon the total weight of the dough taken as 100% by weight.

The dough was removed from the mixer and rolled into a log having a diameter of 1.25 inches. The log was then sliced into 0.5-inch thick, disc-shaped pieces (40 grams/cookie). The center of each disc was then pressed to form a depression of about 0.75 inches in diameter as shown on the right side of FIG. 1A, and illustrated in FIGS. 1B-1C. The individual pieces were then frozen and stored in the freezer until used. To bake the dough, a piece of the frozen cookie dough was removed from the freezer and placed directly onto a microwave-safe plate in the microwave (1100 W output) with the depression facing up. The frozen dough was microwaved on full power for 26 seconds. The microwave baked cookie was then removed from the microwave. The edges of the cookie were slightly doughy immediately out of the microwave, but quickly firmed up as the residual heat inside the cookie continued to cook the dough at the edge. It was observed that the depression in the center of the dough had sealed and the finished cookie had the appearance of a traditional oven-baked cookie as shown on the left side of FIG. 1A. The resulting cookie was moist and chewy.

### Example 2

### Chocolate Chip Cookie

In this Example, a chocolate chip cookie dough was prepared from the ingredients in Table 2 below, frozen, and then baked in a microwave oven directly from the raw frozen stage (i.e., without thawing or prebaking). The dough was prepared using a commercial mixer by first creaming the granulated sugar, molasses, and trans fat free shortening (Trancendim™; available from Ventura Foods, Brea, Calif.) for 1 minute at low speed, and 4 minutes at high speed. The egg was added and mixed for 2 minutes at high speed. The base mixture was then added to this mixture, along with the rice flour, pastry flour, and chocolate chips, and mixed for 2 minutes at low speed until combined.

TABLE 2
Chocolate Chip Cookie

| | % by weight^{A} |
|---|---|
| Ingredients | |
| Granulated Sugar | 12.75 |
| Trans-fat free shortening | 8.93 |
| Molasses | 1.41 |
| Fresh Egg | 13.56 |
| Pastry Flour | 21.83 |
| Rice Flour | 14.44 |
| Chocolate Chips | 12.08 |
| Base Mixture | |
| Rice Flour | 6.90 |
| Corn Syrup Solids | 6.03 |
| Glycerin | 0.41 |
| Baking Powder | 0.31 |
| Sodium Stearoyl Lactylate | 0.14 |
| Sodium Carboxymethyl Cellulose | 0.26 |
| Guar Gum | 0.26 |
| Xanthan Gum | 0.26 |
| α-Amylase | 0.20 |
| Vanillin | 0.13 |
| Salt | 0.07 |
| Sucralose | 0.03 |

^{A}based upon the total weight of the dough taken as 100% by weight.

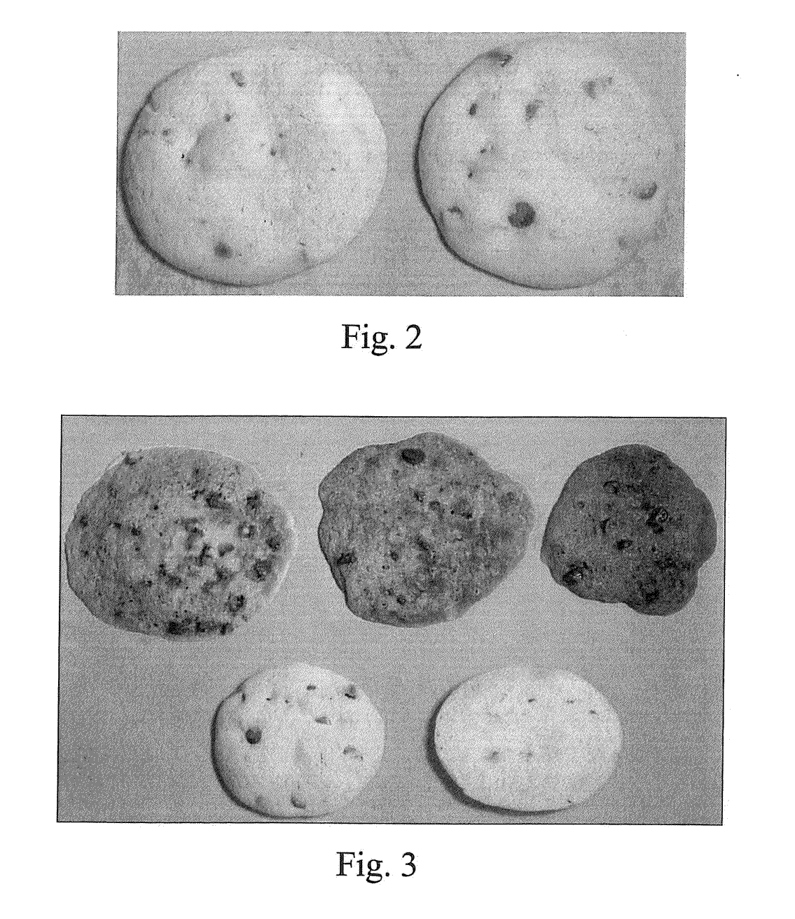

The dough was removed from the mixer and a piece of dough was separated and weighed to 56.5=0.5 grams. The piece was shaped into a round form and pressed into a disc having a 3-inch diameter that was about 0.4 inches thick. The disc was then frozen. To bake the dough, a piece of the frozen cookie dough was removed from the freezer (−4° F.) and placed off-center on a microwave-safe plate in the microwave (1100 W output). The frozen dough was microwaved at 30% power for 2 minutes. The microwave baked cookie (FIG. 2) was then removed from the microwave. The cookie spread, crumb structure, texture and overall baked shape were acceptable, and the overall quality of the cookie was similar to a traditional oven-baked cookie, except for the lack of browning in the microwave-baked cookies.

Three commercially-available refrigerated cookie doughs were also microwave-baked for comparison. The products tested were:

Nestlé Tollhouse Chocolate Chip Cookie Dough (tub variety)—Ingredients: bleached enriched flour (wheat flour, niacin, reduced iron, thiamin, mononitrate, riboflavin, folic acid), nestle toll house morsels (semi-sweet chocolate [sugar, chocolate, cocoa butter, milkfat, soy lecithin, vanillin—an artificial flavor, natural flavor]), sugar, margarine (palm oil, soybean oil, water, salt, vegetable mono- and diglycerides, soy lecithin, sodium benzoate [a preservative], citric acid, natural and artificial flavor, vitamin A palmitate added, beta carotene color, whey), water, molasses, eggs, egg yolks, baking soda, salt, vanilla extract, vanillan.

Pillsbury Chocolate Chip Cookie Dough (roll variety)—Ingredients: enriched flour bleached (wheat flour, niacin, iron, thiamin mononitrate, riboflavin, folic acid), semisweet chocolate chips (sugar, chocolate liquor, cocoa butter, soy lecithin, natural and artificial flavor, salt, milk), sugar, partially hydrogenated soybean and cottonseed oil, water, molasses, eggs, salt, baking soda, sodium aluminum phosphate, natural, and artificial flavors.

Best Choice Chocolate Chip Cookie Dough (roll variety)—Ingredients: enriched bleached flour (wheat flour, niacin, iron, thiamin mononitrate (vitamin b1), riboflavin (vitamin b2), folic acid), chocolate chips (sugar, chocolate liquor, cocoa butter, dextrose, soy lecithin, milk fat, vanillin), sugar, vegetable oil (palm, soybean and/or cottonseed oils), citric acid (preservatives), water, eggs; contains 2% or less of each of the following: skim milk, molasses, salt, baking soda, natural and artificial flavors, and soy flour.

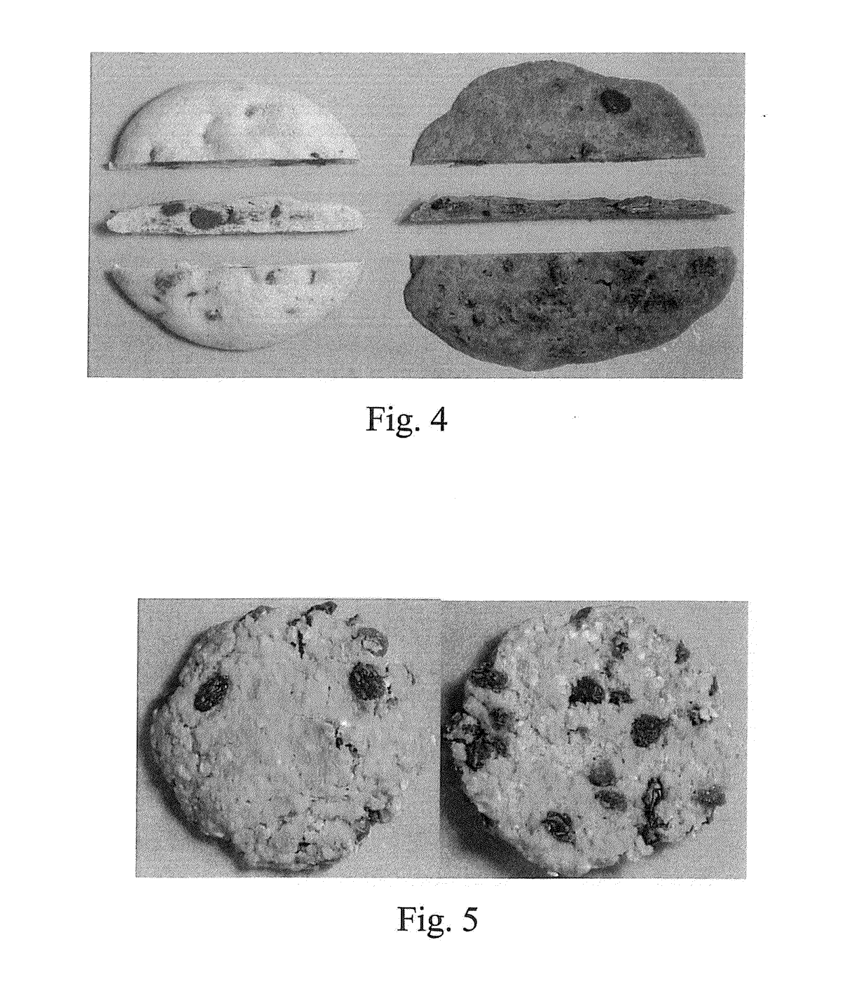

All testing parameters remained the same except that the commercially-available refrigerated cookie dough was microwave-baked from the refrigerated state (per manufacturer's directions). The results of the comparison are shown in the photographs in FIGS. 3-4. The refrigerated cookie dough spread out too much during baking, resulting in a flat cookie, as shown at the top of FIG. 3: Left: Nestlé; Middle: Pillsbury; Right: Best Choice. The commercially-available cookies also had undesirable crumb structure, internal texture, and shape (FIG. 4, right side; Nestlé), as compared to the inventive microwaved cookie (FIG. 3, bottom; FIG. 4, left side).

### Example 3

### Oatmeal Raisin Cookie

In this Example, an oatmeal raisin cookie dough was prepared from the ingredients in Table 3 below, frozen, and then baked in a microwave oven directly from the raw, frozen stage (i.e., without thawing or pre-baking). The dough was prepared using a commercial mixer by first creaming the granulated sugar, molasses, and trans fat free shortening (Trancendim™; available from Ventura Foods, Brea, Calif.) for 1 minute at low speed, and 4 minutes at high speed. The egg was added and mixed for 2 minutes at high speed. The remaining ingredients were added and mixed at low speed until homogeneous.

TABLE 3
Oatmeal Raisin Cookie

| Ingredients | % by weight^{A} |
|---|---|
| Granulated Sugar | 11.68 |
| Trans-fat free shortening | 8.18 |
| Molasses (liquid) | 1.30 |
| Fresh Egg | 12.42 |
| Pastry Flour | 9.15 |
| Oatmeal | 27.49 |
| Raisins | 13.74 |
| NFDM | 1.83 |
| Cinnamon | 0.46 |
| Rice Flour | 6.32 |
| Corn Syrup Solids | 5.53 |
| Glycerin | 0.38 |
| Baking Powder | 0.28 |
| Sodium Stearoyl Lactylate | 0.13 |
| Sodium Carboxymethyl Cellulose | 0.24 |
| Guar Gum | 0.24 |
| Xanthan Gum | 0.24 |
| α-Amylase | 0.18 |
| Vanillin | 0.12 |
| Salt | 0.06 |
| Sucralose | 0.03 |

^{A}based upon the total weight of the dough taken as 100% by weight.

The dough was removed from the mixer and a piece of dough was separated and weighed to 56.5±0.5 grams. The piece was shaped into a round form and pressed into a disc having a diameter of about 3 inches and a thickness of about 0.4 inches, and then frozen. To bake the dough, a disc was removed from the freezer, sprayed on the top and bottom with a browning agent solution (Maillose®; Red Arrow) diluted 1:2 in water, and placed off-center on a microwave-safe surface in the microwave (1100 W output). The frozen dough was microwaved at 30% power for 2 minutes. The microwave baked cookie was then removed from the microwave. As shown in FIG. 5, the cookie spread, crumb structure, texture, flavor, color, and overall baked shape were acceptable, and the overall quality of the cookie was similar to a traditional oven-baked cookie, including the browning of the microwave-baked cookie.

### Example 4

### Additional Cookie Formulations

In this Example, sugar cookies, chocolate chip cookies, and oatmeal raisin cookies were prepared using the cookie base formula in Table 4 below, frozen, and then baked in a microwave oven directly from the raw, frozen stage (i.e., without thawing or pre-baking).

TABLE 4
Cookie Base Formula

| Ingredients | % by weight^{A} |
|---|---|
| Rice Flour | 49.51 |
| Corn Syrup Solids | 30.18 |
| NFDM | 10.00 |
| Glycerin | 2.04 |
| Baking Powder | 1.53 |
| Guar Gum | 1.28 |
| Sodium Carboxymethyl Cellulose | 1.28 |
| Xanthan Gum | 1.28 |
| α-amylase | 1.02 |
| Sodium Stearoyl Lactylate | 0.72 |
| Vanillin | 0.63 |
| Salt | 0.36 |
| Sucrolose | 0.17 |

^{A}based upon the total weight of the dough taken as 100% by weight.

### 1. Sugar Cookie Formulation

To prepare the sugar cookies, the ingredients from Table 5 were mixed with the cookie base formulation using the procedure described below.

TABLE 5
Sugar Cookie

| Ingredients | % by weight^{A} |
|---|---|
| Granulated Sugar | 12.75 |
| Trans-fat free Shortening | 8.93 |
| Fresh Egg | 13.56 |
| Pastry Flour | 26.58 |
| Rice Flour | 18.18 |
| Cookie Base Formula | 20.00 |

^{A}based upon the total weight of the dough taken as 100% by weight.

The sugar cookie dough was prepared using a commercial mixer by first creaming the granulated sugar and trans fat free shortening (Trancendim™; available from Ventura Foods, Brea, Calif.) for 1 minute at low speed, and 4 minutes at high speed. The egg was added and mixed for 2 minutes at high speed. The remaining ingredients were added and mixed for 2 minutes at low speed until homogeneous.

### 2. Chocolate Chip Cookie Formulation

To prepare the chocolate chip cookies, the ingredients from Table 6 were mixed with the cookie base formulation using the procedure described below.

TABLE 6
Chocolate Chip Cookie

| Ingredients | % by weight^{A} |
|---|---|
| Granulated sugar | 12.75 |
| Trans-fat free shortening | 8.93 |
| Molasses (liquid) | 1.41 |
| Fresh Egg | 13.56 |
| Pastry Flour | 19.83 |
| Chocolate Chips | 12.08 |
| Rice Flour | 11.44 |
| Cookie Base Formula | 20.00 |

^{A}based upon the total weight of the dough taken as 100% by weight.

The chocolate chip cookie dough was prepared using a commercial mixer by first creaming the granulated sugar, molasses, and trans fat free shortening (Trancendim™; available from Ventura Foods, Brea, Calif.) for 1 minute at low speed, and 4 minutes at high speed. The egg was added and mixed for 2 minutes at high speed. The remaining ingredients were added and mixed for 2 minutes at low speed until homogeneous.

### 3. Oatmeal Raisin Cookie Formulation

To prepare the oatmeal raisin cookies, the ingredients from Table 7 were mixed with the cookie base formulation using the procedure described below.

TABLE 7
Oatmeal Raisin Cookie

| Ingredients | % by weight^{A} |
|---|---|
| Granulated Sugar | 11.68 |
| Trans-fat free shortening | 8.18 |
| Molasses (liquid) | 1.30 |
| Fresh Egg | 12.42 |
| Oatmeal | 27.49 |
| Raisins | 13.74 |
| Pastry Flour | 6.41 |
| Cinnamon | 0.46 |
| Cookie Base Formula | 18.32 |

^{A}based upon the total weight of the dough taken as 100% by weight.

The oatmeal raisin cookie dough was prepared using a commercial mixer by first creaming the granulated sugar, molasses, and trans fat free shortening (Trancendim™; available from Ventura Foods, Brea, Calif.) for 1 minute at low speed, and 4 minutes at high speed. The egg was added and mixed for 2 minutes at high speed. The remaining ingredients were added and mixed at low speed until homogeneous.

### 4. Cookie Dough Analysis

For each dough, after mixing, the dough was removed from the mixer and a piece of dough was separated and weighed to about 56.5±0.5 grams. The piece was shaped into a round form and pressed into a 3-inch diameter disc and then frozen in a blast freezer for about an hour. The frozen discs were then stored in a regular freezer (−4° F.) until ready to bake. To bake the dough, a disc was removed from the freezer, sprayed on the top and bottom (except for the sugar cookie) with a browning agent solution (Maillose®; Red Arrow) diluted 1:2 in water, and placed off-center on a microwave-safe surface in the microwave (1100 W output). The frozen dough was microwaved at 30% power for 2 minutes. The microwave baked cookie was then removed from the microwave and the internal temperature was recorded. The temperature of the sugar cookie and chocolate chip cookie each ranged from about 170-198° F., while the oatmeal raisin cookie ranged from about 150-198° F. The diameter, thickness, exact weight, and moisture of each piece of dough before baking and of the resulting cookie immediately after baking is shown in Table 8 below, along with the spread ratio. The moisture content of each cookie 24 hours alter baking is also shown.

TABLE 8
Raw and Baked Cookie Data

| | | Diameter | Thickness | Weight | Moisture^{A} | Spread | Moisture^{B} |
|---|---|---|---|---|---|---|---|
| Cookie | | (in.) | (in.) | (g) | (%) | Ratio | (%) |
| Sugar | Dough | 3.02 | 0.38 | 56.77 | 17.34 | 5.11 | 13.65 |
| | Cookie | 3.35 | 0.66 | 54.10 | 13.09 | | |
| | Gain/loss (%) | 11.03 | 75.00 | −4.70 | −24.51 | | |
| Chocolate | Dough | 3.15 | 0.38 | 56.60 | 16.47 | 6.21 | 15.66 |
| Chip | Cookie | 3.75 | 0.60 | 54.30 | 14.08 | | |
| | Gain/loss (%) | 19.21 | 61.11 | −4.06 | −14.54 | | |
| Oatmeal | Dough | 2.99 | 0.38 | 56.63 | 18.41 | 5.46 | 15.46 |
| Raisin | Cookie | 3.35 | 0.61 | 54.83 | 17.30 | | |
| | Gain/loss (%) | 21.20 | 63.89 | −3.01 | −6.03 | | |

^{A}Moisture content of dough before baking and cookie immediately after baking.
^{B}Moisture content of cookie 24 hours after baking.

Texture profile measurements were collected 1 minute after microwave-baking using a TA.XT2 Texture Analyzer (from Stable Micro Systems™ Ltd., Surrey, UK) and a 1.5-inch diameter acrylic cylinder (probe). The TA.XT2 settings are provided in Table 9 below.

TABLE 9
TA.XT2 Settings

| | | | |
|---|---|---|---|
| Pre-Test Speed | 5 mm/sec | Speed | Probe Speed while |
| | | | searching for the trigger point |
| Test Speed | 5 mm/sec | Speed | Speed of approach to target |
| | | | distance (after triggering) |
| Post-Test Speed | 5 mm/sec | Speed | Speed at which the probe |
| | | | returns to the start point |
| | | | after second cycle |
| Target Mode | 1 = Stain | List | |
| Strain | 50% | Strain | |
| Trigger Type | 0 = auto | List | How the initiation of data |
| | (force) | | capture is defined |
| Trigger Force | 5 g | Force | Amount of force for the TA |
| | | | to initiate data capture |

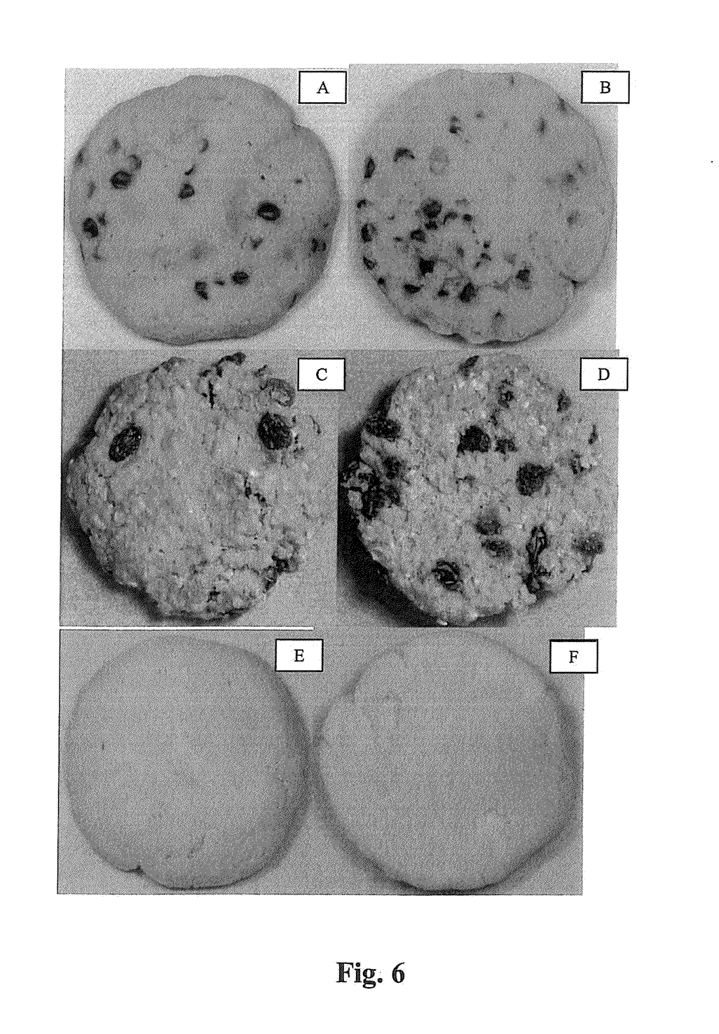

Photographs of each type of microwave-baked cookie (top and bottom) are provided in FIG. 6. About 6 to 8 cookies of each type were tested. Firmness is defined as the maximum peak force during the first compression cycle (first bite). Cohesiveness is how well the product withstands a second deformation relative to how it behaved under the first deformation. It is measured as the ratio of the positive force area during the second compression to that force during the first compression. Springiness is how well a product physically springs back after it has been deformed during the first compression. Springiness is calculated as the ratio of the time reaching the maximum peak force in second compression to that time during the first compression. Chewiness equals firmness×cohesiveness×springiness. The results of the Texture Analysis are shown in Table 10 below.

TABLE 10
Texture Profile Data

| | | | Chewiness | |
|---|---|---|---|---|
| Cookie | Firmness (g) | Cohesiveness | (G) | Springiness |
| Sugar | 4043.11 | 0.33 | 832.37 | 0.62 |
| Chocolate Chip | 2084.41 | 0.33 | 344.05 | 0.49 |
| Oatmeal Raisin | 3801.35 | 0.32 | 629.95 | 0.52 |
| Average Std. | 557.58 | 0.01 | 136.11 | 0.08 |

Texture measurements were then collected 24 hours after microwave-baking using a TA.XT2 Texture Analyzer (from Stable Micro Systems™ Ltd., Surrey, UK) and a 3-points bending rig (HDP-3PB). The TA.XT2 settings are provided in Table 11 below.

TABLE 11
TA.XT2 Settings

| | | | |
|---|---|---|---|
| Pre-Test Speed | 1 mm/sec | Speed | Probe Speed while |
| | | | searching for the trigger point |
| Test Speed | 3 mm/sec | Speed | Speed of approach to target |
| | | | distance (after triggering) |
| Post-Test Speed | 10 mm/sec | Speed | Speed at which the probe |
| | | | returns to the start point |
| | | | after second cycle |
| Target Mode | Distance | List | |
| Trigger Type | 0 = auto | List | How the initiation of data |
| | (force) | | capture is defined |
| Trigger Force | 50 g | Force | Amount of force for the TA to |
| | | | initiate data capture |
| Break Mode | Off | | |
| Stop plot at | Start | | |
| | position | | |

The results of the texture analysis are below. Hardness is defined as the mean maximum peak force to break the cookie. Fracturability is defined as the mean distance compressed before breaking value.

TABLE 12
Cookie Texture Data (24 hours)

| Cookie | Hardness (g) | Fracturability (mm) |
|---|---|---|
| Sugar | 5168.45 | 3.45 |
| Chocolate Chip | 4470.29 | 3.45 |
| Oatmeal Raisin | 8276.08 | 3.46 |

We claim:

1. A method of microwave-baking a cookie, said method comprising:
placing a piece of frozen cookie dough in a microwave oven; and
microwaving the cookie dough to yield a microwave-baked cookie, wherein a susceptor is not used during said microwaving.

2. The method of claim 1, said cookie dough comprising a mixture of flour, sweetening agent, egg, fat, corn syrup solids, glycerin, an enzyme, a gum system, a dough conditioner, a chemical leavening agent, and a carrier.

3. The method of claim 1, wherein said microwave oven has an energy output of from about 500 W to about 2000 W.

4. The method of claim 1, said microwaving being for about 30 seconds to about 240 seconds.

5. The method of claim 1, further comprising coating said cookie dough with a browning agent prior to said placing.

6. The method of claim 1, wherein said cookie dough piece has a maximum surface-to-surface dimension of from about 0.5 inches to about 6 inches.

7. The method of claim 1, wherein said cookie dough piece has an average thickness of from about 0.05 inches to about 2 inches.

8. The method of claim 1, wherein said microwave-baked cookie has a maximum surface-to-surface dimension of from about 0.51 inches to about 9 inches.

9. The method of claim 1, wherein said frozen cookie dough has not been pre-baked.

10. The method of claim 1, said frozen cookie dough piece being in the shape of a disc having a diameter, wherein the diameter of said microwave-baked cookie is less than about 40% greater than the diameter of the frozen cookie dough piece.

11. A microwavable cookie dough composition comprising a mixture of:
from about 0.01% to about 20% by weight corn syrup solids;
from about 0.1% to about 0.8% by weight glycerin;
from about 0.1% to about 5% by weight of a gum system;
an enzyme;
a dough conditioner;
a chemical leavening agent;
a carrier;
a flour;
a sweetening agent;
an egg; and
a fat, wherein said % by weight are based upon the total weight of the composition taken as 100% by weight.

12. The composition of claim 11, wherein said gum system comprises xanthan gum, guar gum, and cellulose derivatives.

13. The composition of claim 12, wherein said xanthan gum, guar gum, and cellulose derivatives are included in the composition in a 1:1:1 ratio by weight.

14. The composition of claim 11, wherein said enzyme is selected from the group consisting of amylases, glucosidases, cellulases, xylanase, transglutaminases, and mixtures thereof.

15. The composition of claim 14, wherein said enzyme is α-amylase.

16. The composition of claim 11, said composition further comprising flavoring agents, spices, and salt.

17. The composition of claim 11, said composition further comprising an additional ingredient selected from the group consisting of cereals, food pieces, milk solids, and mixtures thereof.

18. The composition of claim 11, said composition having a moisture content of from about 5% to about 30% by weight, based upon the total weight of the composition taken as 100% by weight.

19. The composition of claim 11, wherein said carrier is selected from the group consisting of rice flour, tapioca starch, corn starch, sweet potato starch, tapioca flour, corn flour, brown rice flour, sorghum flour, potato flour, amaranth flour, millet flour, quinoa flour, teff flour, and mixtures thereof.

20. The composition of claim 11, wherein said dough conditioner is selected from the group consisting of sodium stearoyl lactylate, calcium stearoyl lactylate, mono- or diglycerides, and combinations thereof.

21. The composition of claim 11, wherein said sweetening agent is a natural sweetener selected from the group consisting of granulated sugars, molasses, honey, maple syrup, corn syrup, brown rice syrup, golden syrup, stevia, and mixtures thereof.

22. The composition of claim 21, comprising:
from about 1% to about 60% by weight of said flour;
from about 5% to about 50% by weight granulated sugar;
from about 1% to about 40% by weight egg; and
from about 1% to about 30% by weight fat, said % by weight being based upon the total weight of the composition taken as 100% by weight.

23. The composition of claim 22, further comprising from about 0.01% to about 20% by weight molasses, based upon the total weight of the composition taken as 100% by weight.

24. The composition of claim 21, said composition further comprising an artificial sweetener.

25. The composition of claim 11, wherein said fat is a trans-fat free shortening.

26. A generally disc-shaped cookie dough piece having an outer perimeter and an upper surface, said dough piece having a first average thickness around said outer perimeter, and said upper surface including a depression formed therein and having a second average thickness, wherein the second average thickness is from about 0% to about 30% of said first average thickness.

27. The cookie dough piece of claim 26, said dough piece having an average diameter D, and said depression 16 having an average diameter D′, where D′ is from about 10% to about 50% of D.

28. The cookie dough piece of claim 26, said cookie dough comprising a mixture of flour, sweetening agent, egg, fat, corn syrup solids, glycerin, an enzyme, a gum system, a dough conditioner, a chemical leavening agent, and a carrier.

29. The cookie dough piece of claim 26, said piece being in a frozen state.
